(19) United States
(12) Patent Application Publication
(10) Pub. No.: US 2014/0019811 A1
(43) Pub. Date: Jan. 16, 2014

(54) COMPUTER SYSTEM PERFORMANCE MARKERS

(71) Applicants: Rajesh R. Bordawekar, Yorktown Heights, NY (US); Peter F. Sweeney, Spring Valley, NY (US)

(72) Inventors: Rajesh R. Bordawekar, Yorktown Heights, NY (US); Peter F. Sweeney, Spring Valley, NY (US)

(73) Assignee: INTERNATIONAL BUSINESS MACHINES CORPORATION, Armonk, NY (US)

(21) Appl. No.: 13/546,537

(22) Filed: Jul. 11, 2012

(51) Int. Cl. G06F 11/30

(52) U.S. Cl. 714/47.1; 714/E11.179

(57) ABSTRACT

Identifying computer system markers to understand computer system performance, in one aspect, may comprise identifying a set of executions of applications indicative of computer performance based on first values associated with a first set of artifacts in the set of executions. Two subsets of executions from said identified set of executions are selected based on second values associated with a second set of artifacts in the set of executions. One or more markers are identified by determining one or more third set of artifacts from the two subsets of executions that have an associated third value that is different in a first of the two subsets from a second of the two subsets of executions according to a criterion.

### FIELD

The present application relates generally to computers, computer systems, applications and tools, and computer performance assessment, and more particularly to identifying performance problems in computing systems and applications.

### BACKGROUND

Understanding the performance of modern day computer systems is a difficult and complex task. For instance, analyzing performance of computer systems involves tedious and manual endeavors. Specifically, because hardware is complex, it may not be possible to always measure hardware components that impact performance. Even if measured, it is not easy to know how to interpret those measurements. Similarly, today's computer systems employ complex software which contain multiple frameworks and libraries. To compound the complexity, the same framework and library behave differently in different contexts or environments such as different operating systems, virtual machines, applications, middleware, and hardware.

When a performance problem is present in a computer system, it is not easy to tell where to look to find the problem. While there are a number of point tools that are available (e.g., tprof, Java™ lock manager (JLM)), those are only useful if one already knows what the problem is. Triage tools, such as WAIT, provide high level whole system view of an application execution. However, even with these tools, one still has to navigate the information in the tool to locate the problem.

### BRIEF SUMMARY

A method and system for identifying computer system markers to understand computer system performance may be provided. The method, in one aspect, may comprise identifying a set of executions of applications indicative of computer performance based on first values associated with a first set of artifacts in the set of executions. The method may also comprise selecting two subsets of executions from said identified set of executions, said two subsets selected based on second values associated with a second set of artifacts in the set of executions. The method may further comprise determining one or more third set of artifacts from the two subsets of executions that have an associated third value that is different in a first of the two subsets from a second of the two subsets of executions according to a criterion, the determined one or more third set of artifacts representing one or more markers respectively.

A system for identifying computer system artifacts to understand computer system performance, in one aspect, may comprise a filter module operable to execute on a processor and identify a set of executions of applications indicative of computer performance based on first values associated with a first set of artifacts in the set of executions. A partition module may be operable to select two subsets of executions from the identified set of executions, the two subsets selected based on second values associated with a second set of artifacts in the set of executions. A marker module may be operable to determine one or more third set of artifacts from the two subsets of executions that have an associated third value that is different in a first of the two subsets from a second of the two subsets of executions according to a criterion. The determined one or more third set of artifacts represent one or more markers respectively.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates a method of identifying computer system markers of the present disclosure in one embodiment.

FIG. 2 illustrates a structure organization of artifacts in one embodiment of the present disclosure.

FIG. 3 illustrates a method in one embodiment for identifying a subset of executions such that reasoning about their performance is meaningful.

FIG. 4 illustrates a method in one embodiment of the present disclosure for partition executions, that is, selecting two subsets of executions that identify a difference along a selected performance dimension.

FIG. 5 illustrates a method in one embodiment for identifying artifacts that impact performance.

FIG. 6 illustrates a method in another embodiment that identifies artifacts that impact performance.

FIG. 7 is a flow diagram illustrating a method generally of identifying computer system markers of the present disclosure in one embodiment.

FIG. 8 is a diagram illustrating a computer system which may run the methodologies disclosed herein.

### DETAILED DESCRIPTION

In one embodiment of the present disclosure, “markers” that indicate specific behavior of a computer system may be determined from artifacts, which are derived by executing an application An artifact is data associated with the execution of a computer system. Data mining techniques and/or supervised machine learning techniques may be applied to artifacts for such determination. The markers may then be used to identify performance bottlenecks. Once a bottleneck has been identified, the user may be shown where to look to fix the bottleneck. The markers may be also used to predict behavior in a different context for capacity planning.

The behavior of a computer system, when it is executing, can be captured by a set of artifacts, where an artifact is represented by key value pair, <key, value>, and the key is determined by the type of the artifact. Artifact types include, but not limited to, configuration artifacts that may characterize hardware (HW) configuration, memory hierarchy configuration, operating system (OS) version, compiler version and optimization level, and others; Application artifacts that may characterize threads, call stacks, stack frames, and others associated with a running application; Performance artifacts that may characterize processor utilization (such as central processing unit (CPU) utilization), memory utilization, disk utilization, network utilization, average OS run queue size, response time, throughput, and other machine resource related information. Such artifacts may be collected over many executions. In the present disclosure in one embodiment, methodologies are presented that use these collections of artifacts to reason about and understand performance and identify those artifacts which may be useful and provide insight in understanding performance. For example, application artifacts are identified that impact performance.

An artifact's key refers to an attribute of a computer system and has one or more values associated with it. For example, an artifact's key may be “processor” and the artifact's value associated with that key may be “PowerPC”. As another example, an artifact key may be “response time” and the associated valued may be “2 seconds”.

In general, configuration artifacts are those provide information about the environment context within which an application is running. Configuration artifacts may be fixed with respect to a running application, e.g., the environment context such as hardware configuration and operating system usually does not change while an application is running. Application artifacts provide information about dynamic behavior of the application while the application is running; e.g., call stacks, threads, and stack frames are dynamically updated as a program runs. Performance artifacts provide information about the machine resources while the application is running. The information contained in performance artifacts may be with respect to the application as well as other actions happening in the computer system while the application is running. Because both the application and performance artifacts provide information that is generated or available while the application is running, these artifacts may be organized as a time series; that is, as a sequence of values collected at distinct intervals. Time can be model by converting an artifact as a triple, <key, value, time>, where time is incorporated as the third element of the triple. Time allows the correlation between different types of artifacts. For example, knowing what application artifacts, such as call stacks, correlate to performance artifacts, such as response time.

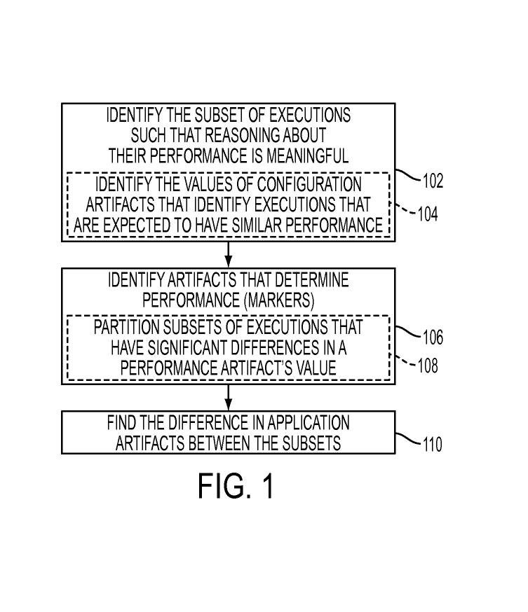

FIG. 1 illustrates a method of the present disclosure in one embodiment. Given a set of executions, at 102, the method may include identifying a subset of executions such that reasoning about their performance is meaningful. This may be done, for example, by identifying the values for configuration artifacts that represent executions that are expected to have similar performance as shown at 104. As counter example, if one execution (E1) and another execution (E2) represent the executions of different applications running different hardware systems (for example, a super computer and a mobile phone), comparing their performance may not have any meaning. On the other hand, if E1 and E2 represent executions of applications running on similar hardware system or configuration, comparison of their performance may provide insight into further understanding of the computer system E1 and E2 are executing on or of the applications themselves.

The method may also include identifying what artifacts determine performance at 106, for instance, employing a supervised machine learning technique. This may be done, for example, by selecting two subsets of executions that identify a difference in a performance artifact's value at 108. Examples may include, but are not limited to, response time, throughput, disk activity, network activity, CPU utilization, or others. For instance, consider response time selected as a performance artifact. The method of the present disclosure, in one embodiment, may select two subsets of executions that have different values for response time, for instance, one subset that exhibits good response time and another subset that has bad response time. Whether the response time is good or bad may be determined based on defined criteria or threshold values. As another example, consider disk activity as a selected performance artifact, where one subset of executions exhibit low disk activity and another subset of executions exhibit high disk activity.

The method of the present disclosure may also include, given the two subsets of executions, finding the difference in application artifacts between the subsets at 110. The difference is expected to explain the difference in the performance artifact value. Those identified application artifacts may be considered as markers that impact computer system performance.

An embodiment of the present disclosure organizes the artifacts of an execution into a structured representation that allows finding and comparing artifacts from two or more different executions. For example, the artifacts of an execution may be represented as a tree, where each node is a <key, value>pair and each edge represents a refinement.

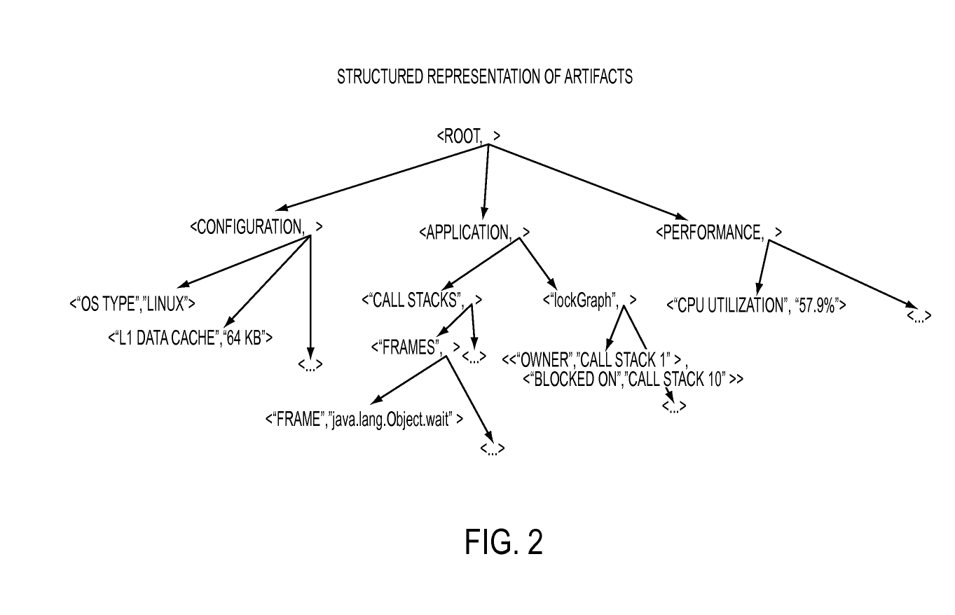

The value component of a pair may be represented as a value. For example, if the key is “OS type”, the associated value might be “Linux”. Value component of a pair may be represented also as a list of nodes. For example, the value component of the hardware artifact might be represented as a list of hardware component nodes, and one hardware component node, for example, might have the key “L1 data cache” and have the value of “64 Kbytes”. “A list of nodes” represents a refinement and introduces an edge for each node in the list. The value of the root node is a list of nodes, one for each artifact type (configuration, application, performance). The value of an artifact can have structure. For example, if the artifact is a call stack, its value is a sequence of stack frames. Its values could be partitioned by the thread type the call stack is associated with. FIG. 2 illustrates a structure organization of artifacts in one embodiment of the present disclosure.

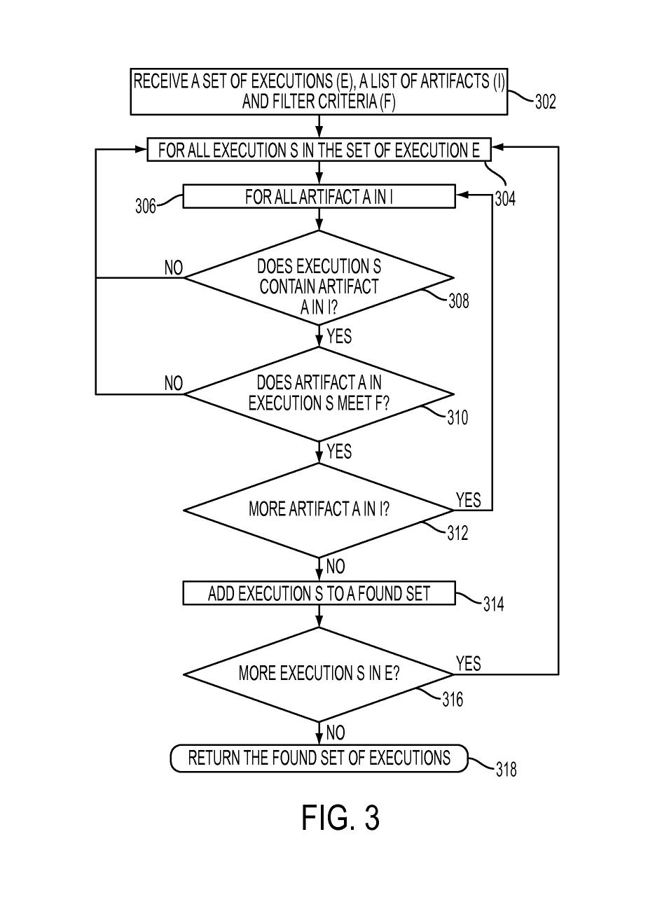

FIG. 3 illustrates a method in one embodiment for identifying a subset of executions such that reasoning about their performance is meaningful. An example pseudo code for the algorithm is shown below.

```
{ S1 } filter(E, I, F) {
  Set executions = { };
  for all S in E {
    found = true;
    for all a in I {
      if a ! in S then { found = false; break }
      if ! F(a)(S) then { found = false; break }
    }
    if found==true then executions += S
  }
  return executions
}
```

The function “filter” takes as input a set of executions, E, a set of artifacts, I, on which the executions are to be filtered, and a filter, F, which specifies criteria for the value of an artifact in I. In one embodiment, artifact set I contains configuration artifacts. This function finds subset of executions whose artifacts (e.g., configuration artifacts) specified by I meet F's criteria. F is a map of predicates, F(a) is the predicate for artifact a, F(a)(S) applies F(a) to the execution S and returns true if S(a), the value of a in S, meets F's criteria.

Referring to FIG. 3, a set of executions, a set of artifacts (e.g., configuration artifacts) and filter criteria are received as input at 302. At 304, the following steps are performed for all executions in the received set of executions. At 306, for each execution S, the following steps are performed for all artifacts specified in the set of configuration artifacts. At 308, it is determined whether an artifact in a is in execution S. If not, S is not added to the list of identified executions and a new execution is examined at 304. If so, at 310, it is determined whether the value of artifact a found in S meets the received filter criteria condition for artifact a. If not, S is not added to the list of identified executions and a new execution is examined at 304. If so, at 312, if there are no more artifacts a in I to be processed, execution S is added to a list of identified or found executions at 314, which list will be returned. The logic continues to 316, and it is determined whether there are more executions that have not been processed in the received set. If so, the logic continues to 304, where another execution S is processed. If not, the list of identified executions is returned. At 318, a set of executions found is returned. Filter criteria may include a threshold, a range of values or other conditions associated with the input set of artifacts. Examples of filter criteria may include, but are not limited to, specifying that an artifact processor type is PowerPC®, number of CPUs=8, OS=AIX®, OS version=6.5 to 7.2.

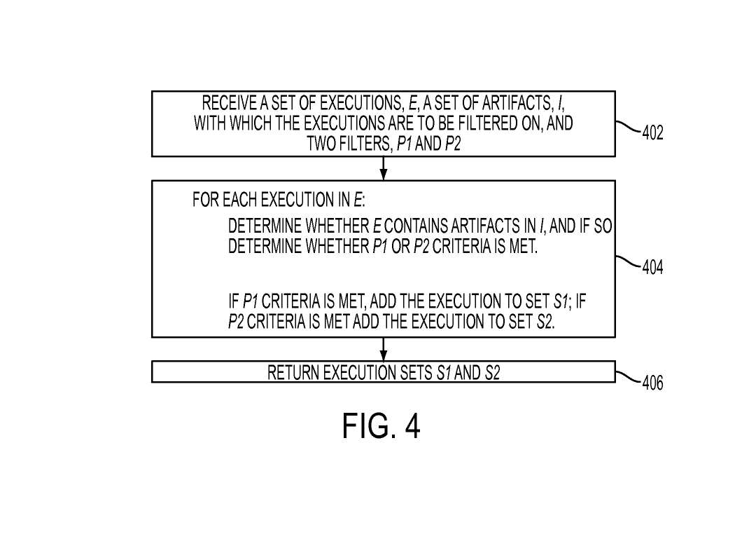

FIG. 4 illustrates a method in one embodiment of the present disclosure for partition executions, that is, selecting two subsets of reports that identify a difference along a selected performance artifact's value. An example pseudo code for the algorithm is shown below.

```
<S1, S2> partition(E, I, P1, P2) {
  Set S1 = S2 = { };
  for all S in E {
    foundS1 = foundS2 = true;
    for all a in I {
      if a ! in S then { foundS1 = foundS2 = false; break }
      if foundS1 == true && ! P1(a)(S) thenfoundS1 = false;
      if foundS2 == true && ! P2(a)(S) then foundS2 = false;
    }
    if foundS1 then S1 += S
    else if foundS2 then S2 += S
  }
return <S1, S2>
}
```

The function partition takes as input a set of executions, E, a set of artifacts, I, with which the executions are to be filtered on, and two filters, P1 and P2, such that given an execution and an artifact, if the value of the artifact in the execution meets P1's criteria, the execution is placed in {S1}, else if the value meets P2's criteria, the execution is placed in {S2}. Partition returns two sets of executions, {S1} and {S2}, whose elements do not overlap. Input I contains performance artifacts in one embodiment of the present disclosure.

Referring to FIG. 4, at 402, a set of executions, E, a set of artifacts, I, with which the executions are to be filtered on, and two filters, P1 and P2 are received. The set of executions E, for instance, may be those returned from the algorithm shown in FIG. 3, those that were filtered based on a set of configuration artifacts. At 404, for all executions in the set of execution, it is determined whether an execution contains the artifacts specified in the set of artifacts, and if so whether the criteria specified by the filters are met. If criteria specified in filter P1 is met, the execution is added to set S1; if criteria specified in filter P2 is met, the execution is added to set S2. At 406, sets S1 and S2 are returned. The algorithm may partition the set executions into two sets, which identity a difference along a selected dimension. Thus, the input set of artifacts may include those that characterize an aspect or dimension of performance of computer system such as CPU utilization; that is, I may include CPU utilization as artifact. P1 filter may specify a condition that identifies low CPU utilization. P2 filter may specify a condition that identifies high CPU utilization. Those executions that satisfy P1 filter condition are grouped into one set. Those that satisfy P2 filter condition are grouped into another set. Thus, two sets of execution are identified that have different values (low vs. high) along a performance dimension (CPU utilization). As another example, I may include average response time as artifact. P1 filter may specify a condition that average response time should be greater than 4 seconds. P2 filter may specify a condition that all response time should be less than 1 second. In this example, P1 filter looks for executions considered to have slow performance; P2 filters look for executions considered to have good performance. Two sets of execution are identified that have different values (slow vs. good) along a dimension of performance (response time). It should be noted that a combination of artifacts and associated filters may be employed to partition the executions into two sets. P1 and P2 may be also referred to as partition criteria.

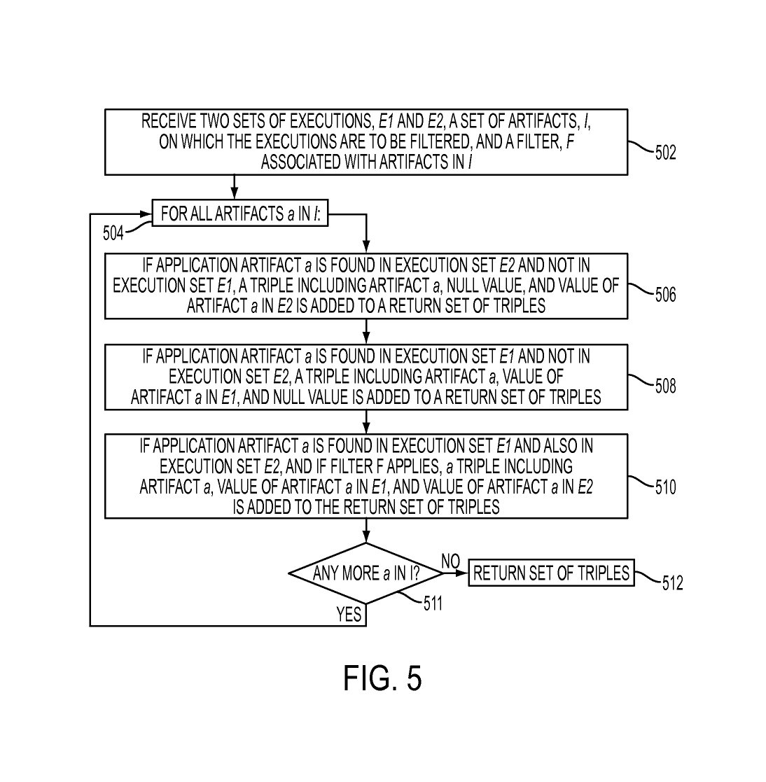

FIG. 5 illustrates a method in one embodiment for identifying artifacts that impact performance. Given the two subsets of executions, for instance, as identified by the method shown in FIG. 4, the algorithm shown in FIG. 5 finds the difference in the artifacts between the subsets. The difference is expected to explain the difference along the performance dimension. Further those artifacts having the difference are considered to be “markers” that can help in understanding the performance of the computer system. An example pseudo code for finding the difference in the artifacts between two subsets of executions is shown below.

```
{<key, value1, value2>} marker(<E1, E2>, I, F) {
  Set triples = { };
for all artifacts a in I
    if a ! in E1 && a ! in E2 then
      continue
    else if a ! in E2 then
      triples += <a, a(E1), null>
    else if a ! in E1 then
      triples += <a, null, a(E2)>
    else if F(a)(E1, E2) then
      triples += <a, a(E1), a(E2)>
  return triples ;
}
```

The marker function takes as input two sets of executions, E1 and E2, a set of artifacts, I, on which the executions are to be filtered, and a filter, F, which returns true for artifact a if the value of a in all the executions in E1 is different than the value of a in all the executions in E2. For every artifact that differs between E1 and E2, the method generates a triple that contains the artifact and its value in E1 and in E2. In one embodiment, I may contain application artifacts.

Referring to FIG. 5, two sets of executions, E1 and E2, a set of artifacts, I, on which the executions are to be filtered, and a filter, F associated with artifacts in I are received at 502. E1 and E2 may be those partitioned according to the method shown in FIG. 4. I contains application artifacts. F specifies one or more conditions associated with application artifacts in I. At 504, for each artifact a in I, steps 506-510 are performed. At 506, if application artifact a is found in execution set E2 and not found in execution set E1, a triple including a null value, and artifact a, value of artifact a in E2 is added to a return set of triples. At 508, if application artifact a is found in execution set E1 and not found in execution set E2, a triple including artifact a, value of artifact a in E1, and null value is added to a return set of triples. At 510, if application artifact a is found in execution set E1 and also in execution set E2, and if filter F applies, a triple including artifact a, value of artifact a in E1, and value of artifact a in E2 is added to the return set of triples. F defines the difference between the value of artifact a in E1 and the value of artifact a in E2. F may be referred to as difference criteria. A simple example of F is a membership test; that is, if a value of attribute a exists in all execution in the execution set E1, but in none of the executions in the execution set E2, then F returns true. If application artifact a is not found in either E1 or E2, nothing is added to the return triple set. At 511, if any more artifacts need to be examined, goto 504. At 512, the set of triples are returned.

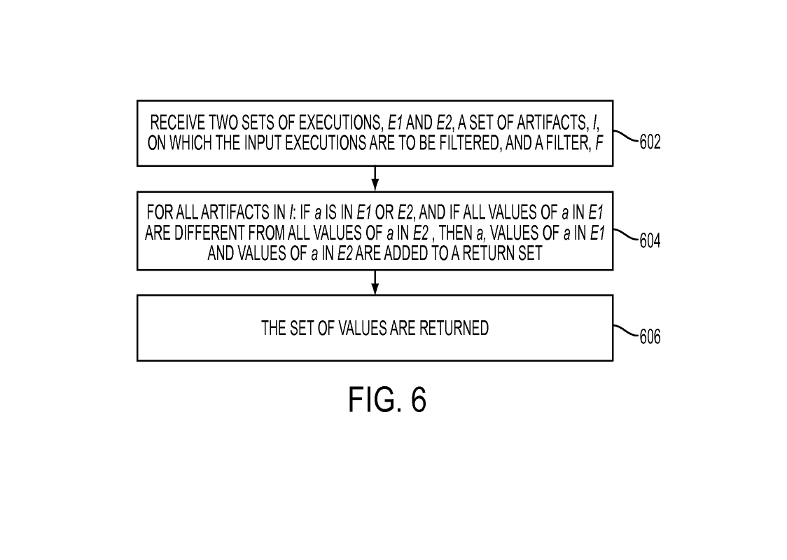

FIG. 6 illustrates a method in another embodiment for finding the difference in artifacts between subsets of execution. Given the two subsets of executions, the method shown in FIG. 6 finds the difference in the artifacts between the subsets. The difference is expected to explain the difference along the performance dimension. An example pseudo code for an algorithm implementing such a method is shown below.

```
{<key, value1, value2>} marker(<E1, E2>, I, F) {
  Set values = { };
  for all artifacts a in I
    if a in E1 || a in E2 then
      if F(a)(E1,E2) then
        values += <a, a(E1), a(E2)>
  return values;
}
```

The marker function takes as input two sets of executions, E1 and E2, a set of artifacts, I, on which the input executions are to be filtered, and a filter, F, which returns true for artifact a if the value of a in all the executions in E1 is different than the value in all the executions in E2. For every artifact that differs between E1 and E2, the algorithm generates a triple that contains the artifact and its value in E1 and in E2. In one embodiment, I contains application artifacts.

Referring to FIG. 6, at 602, two sets of executions, E1 and E2, a set of artifacts, I, on which the input executions are to be filtered, and a filter, F, are received. F is also referred to as difference criteria. At 604, for all artifacts in I, if a is in E1 or E2, and if all values of a in E1 are different from all values of a in E2, then a, values of a in E1 and values of a in E2 are added to a return set. At 608, the set of values are returned.

The following call statement shows employing the above algorithms to identify application artifacts as performance markers which imply difference in performance. A marker is the artifact that determines the performance; Artifact's values are instances of markers. For example, v1 and v2 represent the values (instances of the marker). {<a, v1, v2>}=marker(partition(filter(E, I^{C}, F^{F}), I^{P}, P¹, P²), I^{A}, F^{M})

### Where:

a is an artifact
v1 and v2 are values
E is the set of all executions
I^{C} is a set of configuration artifacts
F^{F} is the filter on the artifacts in I^{C}
I^{P} is a set of performance artifacts
P¹ and P² are the filters on the artifacts in I^{P} that partitions a set of executions
I^{A} is a set of application artifacts
F^{M} is the marker filter on the artifacts in I^{A}

In one embodiment, the user specifies the artifacts I^{C}, I^{P}, I^{A} and the filters F^{F}, P¹, P², F^{M}. The result identifies the application artifacts that effect the change in performance, or behavior of a system, determined by the filters P¹, P² for the artifacts in I^{A}. An artifact may have multiple instances in an execution. For example, if the application artifact is the set of call stacks for all the threads in a multi-threaded application, the algorithms may be extended to iterate over the instances of call stacks.

The identified application artifacts, also referred to as markers, may be organized in different ways: for example, individually as a singleton; or as groups in sets, bags, lists, bags of lists, and others.

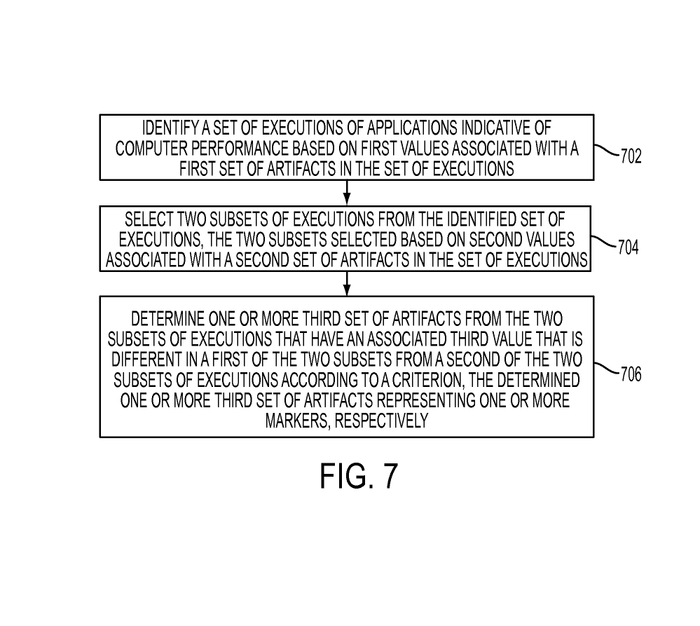

FIG. 7 is a flow diagram illustrating a method generally of identifying computer system markers of the present disclosure in one embodiment. At 702, a set of executions of applications indicative of computer performance are identified based on first values associated with a first set of artifacts in the set of executions. The set of executions of applications may be identified based on the first values that meet a first filter criterion. In one embodiment of the present disclosure, the first set of artifacts may be configuration artifacts that provide information associated with environment context within which the applications are running, and the first values are data instants indicative of the information associated with environment context within which the applications are running. In another embodiment of the present disclosure, the first set of artifacts may be performance artifacts and the first values may include associated values of performance artifacts. Yet in another embodiment of the present disclosure, the first set of artifacts may be application artifacts and the first values may include associated values of application artifacts.

At 704, two subsets of executions are selected from said identified set of executions, said two subsets selected based on second values associated with a second set of artifacts in the set of executions. In selecting the two subsets of executions, the executions of applications in the set having the second values that meet a second criterion are placed in the first of the two subsets and the executions of applications in the set having the second values that meet a third criterion are placed in the second of the two subsets. In one embodiment of the present disclosure, the second set of artifacts may be performance artifacts that provide information associated with the states of the machine resources within which the applications are executing and the second values are data instants indicative of the information associated with states of machine resources within which the applications are running. In another embodiment of the present disclosure, the second set of artifacts may be configuration artifacts and the second values may include associated values of configuration artifacts. Yet in another embodiment of the present disclosure, the second set of artifacts may be application artifacts and the second values may include associated values of application artifacts.

At 706, one or more third set of artifacts are determined from the two subsets of executions that have an associated third value that is different in a first of the two subsets from a second of the two subsets of executions according to a criterion, e.g., a difference criterion. The determined one or more third set of artifacts are representative of one or more markers respectively. In one embodiment of the present disclosure, the third set of artifacts may be application artifacts that provide information associated with execution behavior of the applications while the applications are running and the third value is a data instant indicative of the information associated with execution behavior of the applications while the applications are running. In another embodiment of the present disclosure, the third set of artifacts may be configuration artifacts and the third value may include an associated value of a configuration artifact. Yet in another embodiment of the present disclosure, the third set of artifacts may be performance artifacts and the third value may include an associated value of a performance artifact.

The determined third set of artifacts may identify common artifacts having workloads of same type, common artifacts having all workloads with common access patterns, or common artifacts having common runtime features, or combinations thereof. Furthermore, an affinity measure may be identified between the determined third set of artifacts based on associative rule mining. Yet in another aspect, a function call sequence may be correlated to the determined third set of artifacts. Still yet, dominating artifacts that have most influence on a workload may be identified based on the determined third set of artifacts and associated third values. In addition, performance of a workload on a runtime environment may be predicted based on the determined third set of artifacts. Furthermore, one or more functions that should not be employed may be identified based on observing one or more of the determined third set of artifacts and associated third values. Performance of a workload on a runtime environment may also be identified based on the determined third set of artifacts. In one aspect, the first set of artifacts, the second set of artifacts and the third set of artifacts are independent; that is, no artifact in one set is in any other set.

The methodology discussed above may be practiced in post-mortem analysis of performance data, analysis of the relationships between artifacts, and for predictive performance analysis. For example, during post-mortem analysis, the key artifacts that affect behavior of an application may be identified. Further, “good” and “bad” marker may be determined for a workload using the marker algorithm. For example, common markers may be identified for all workloads of the same type (e.g., WebSphere™ applications); common markers may be identified for all workloads with common access patterns (e.g., JDBC™ workloads); common markers may be identified for common runtime features (e.g., OS, Processors, Language runtimes, etc.).

For intra-marker analysis (relationships between markers), performance markers across configurations may be analyzed. For instance, affinity may be identified between markers using associative rule mining. Such analysis may uncover that if one observes an marker “x”, one is also likely to see markers “y” and “z”. In addition, function call sequences may be correlated to the markers. For example, such correlation may reveal that if one observes an marker “y”, one is also likely to see following function invocations. Still yet, “dominating” markers may be discovered: Markers that have the most influence on the goodness or badness of a workload because they have the highest likelihood of appearing in a class of applications.

The identified markers may be also utilized to predict performance of a workload on different runtime environments, e.g., different Java® runtime features (e.g., GC), different operating system and system features, different machines, and/or different number of processors. The markers may also help in developing scalable programs. For instance, if one observes an marker, one should not use the following functions for performance reasons.

Other applications of the methods shown herein are also contemplated.

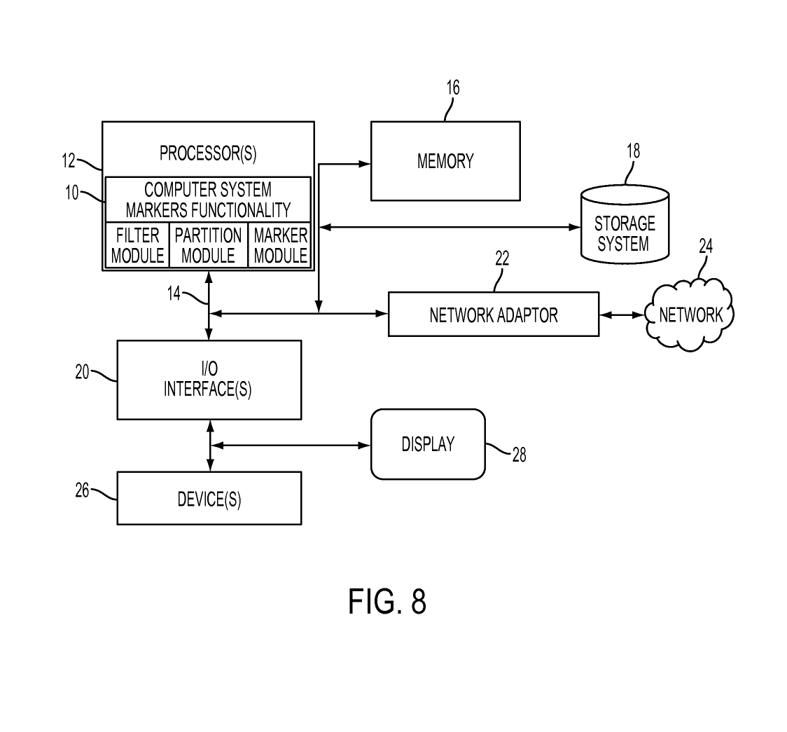

FIG. 8 illustrates a schematic of an example computer or processing system that may implement the computer system markers methodologies in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 8 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a computer system markers module 10 that performs the methods described herein. The module 10 may be programmed into the integrated circuits of the processor 12, or loaded from memory 16, storage device 18, or network 24 or combinations thereof. The module 10 may include functionalities such as those described with reference to FIGS. 1-7.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of identifying computer system markers to understand computer system performance, comprising:
identifying, by a processor, a set of executions of applications indicative of computer performance based on first values associated with a first set of artifacts in the set of executions;
selecting two subsets of executions from said identified set of executions, said two subsets selected based on second values associated with a second set of artifacts in the set of executions; and
determining one or more third set of artifacts from the two subsets of executions that have an associated third value that is different in a first of the two subsets from a second of the two subsets of executions according to a criterion, the determined one or more third set of artifacts representing one or more markers respectively.

2. The method of claim 1, wherein the set of executions of applications are identified based on the first values that meet a first filter criterion.

3. The method of claim 1, wherein in selecting the two subsets of executions, the executions of applications in the set having the second values that meet a second criterion are placed in the first of the two subsets and the executions of applications in the set having the second values that meet a third criterion are placed in the second of the two subsets.

4. The method of claim 1, wherein the first set of artifacts includes configuration artifacts that provide information associated with environment context within which the applications are running, and the first values are data instants indicative of the information associated with environment context within which the applications are running.

5. The method of claim 1, wherein the second set of artifacts includes performance artifacts that provide information associated with states of machine resources within which the applications are executing and the second values are data instants indicative of the information associated with states of machine resources within which the applications are executing.

6. The method of claim 1, wherein the third set of artifacts includes application artifacts that provide information associated with execution behavior of the applications while the applications are running and the third value is a data instant indicative of the information associated with execution behavior of the applications while the applications are running.

7. The method of claim 6, wherein the determined third set of artifacts identifies common artifacts having workloads of same type, identifies common artifacts having all workloads with common access patterns, or identifies common artifacts having common runtime features, or combinations thereof.

8. The method of claim 1, further including:
identifying affinity between the determined third set of artifacts based on associative rule mining.

9. The method of claim 1, further including:
correlating a function call sequence to said determined third set of artifacts.

10. The method of claim 1, further including:
identifying dominating artifacts that have most influence on a workload based on said determined third set of artifacts and associated third values.

11. The method of claim 1, wherein the first set of artifacts, the second set of artifacts and the third set of artifacts are independent.

12. The method of claim 1, further including:
identifying one or more functions that should not be employed based on observing one or more of the determined third set of artifacts and associated third values.

13. A system for identifying computer system artifacts to understand computer system performance, comprising:
a processor;
a filter module operable to execute on the processor and identify a set of executions of applications indicative of computer performance based on first values associated with a first set of artifacts in the set of executions;
a partition module operable to select two subsets of executions from said identified set of executions, said two subsets selected based on second values associated with a second set of artifacts in the set of executions; and
a marker module operable to determine one or more third set of artifacts from the two subsets of executions that have an associated third value that is different in a first of the two subsets from a second of the two subsets of executions according to a criterion, the determined one or more third set of artifacts representing one or more markers respectively.

14. The system of claim 13, wherein the set of executions of applications are identified based on the first values that meet a first filter criterion.

15. The system of claim 13, wherein the partition module in selecting the two subsets of executions, the executions of applications in the set having the second values that meet a second criterion are placed in the first of the two subsets and the executions of applications in the set having the second values that meet a third criterion are placed in the second of the two subsets.

16. The system of claim 13, wherein the first set of artifacts includes configuration artifacts that provide information associated with environment context within which the applications are running, and the first values are data instants indicative of the information associated with environment context within which the applications are running.

17. The system of claim 13, wherein the second set of artifacts includes performance artifacts that provide information associated with states of machine resources within which the applications are executing and the second values are data instants indicative of the information associated with states of machine resources within which the applications are executing.

18. The system of claim 13, wherein the third set of artifacts includes application artifacts that provide information associated with execution behavior of the applications while the applications are running and the third value is a data instant indicative of the information associated with execution behavior of the applications while the applications are running.

19. A computer readable storage medium storing a program of instructions executable by a machine to perform a method of identifying computer system markers to understand computer system performance, comprising:
identifying, by a processor, a set of executions of applications indicative of computer performance based on first values associated with a first set of artifacts in the set of executions;
selecting two subsets of executions from said identified set of executions, said two subsets selected based on second values associated with a second set of artifacts in the set of executions; and
determining one or more third set of artifacts from the two subsets of executions that have an associated third value that is different in a first of the two subsets from a second of the two subsets of executions according to a criterion, the determined one or more third set of artifacts representing one or more markers respectively.

20. The computer readable storage medium of claim 19, wherein the set of executions of applications are identified based on the first values that meet a first filter criterion.

21. The computer readable storage medium of claim 19, wherein in selecting the two subsets of executions, the executions of applications in the set having the second values that meet a second criterion are placed in the first of the two subsets and the executions of applications in the set having the second values that meet a third criterion are placed in the second of the two subsets.

22. The computer readable storage medium of claim 19, wherein the first set of artifacts includes configuration artifacts that provide information associated with environment context within which the applications are running, and the first values are data instants indicative of the information associated with environment context within which the applications are running.

23. The computer readable storage medium of claim 19, wherein the second set of artifacts includes performance artifacts that provide information associated with states of machine resources within which the applications are executing and the second values are data instants indicative of the information associated with states of machine resources within which the applications are executing.

24. The computer readable storage medium of claim 19, wherein the third set of artifacts includes application artifacts that provide information associated with execution behavior of the applications while the applications are running and the third value is a data instant indicative of the information associated with execution behavior of the applications while the applications are running.

25. The computer readable storage medium of claim 19, further including:
predicting performance of a workload on a runtime environment based on said determined third set of artifacts.
